(19) United States
(12) Patent Application Publication
(10) Pub. No.: US 2014/0356590 A1
(43) Pub. Date: Dec. 4, 2014

(54) Direct Printing Composition

(71) Applicant: Dow Corning Corporation, Midland, MI (US)

(72) Inventors: Katherine Hoffee, Whiteland, IN (US); Fernando Vazquez-Carrillo, Summerfield, NC (US); Lauren Tonge, Sanford, MI (US)

(21) Appl. No.: 14/367,347

(22) PCT Filed: Dec. 19, 2012
(86) PCT No.: PCT/US2012/070520

§ 371 Date: Jun. 20, 2014

Related U.S. Application Data
(60) Provisional application No. 61/578,921, filed on Dec. 22, 2011.

(51) Int. Cl. C09D 183/04; D06P 5/00; C08L 83/04

(52) U.S. Cl. CPC C09D 183/04; C08L 83/04; D06P 5/001; D10B 2331/02
USPC 428/196; 524/500; 427/256

(57) ABSTRACT

A direct printing composition comprising (a) a silicone ink base composition and (b) an adhesion promoter.

### CROSS-REFERENCE TO RELATED APPLICATIONS

None

The present invention relates to a direct printing composition useful for textile coating, in particular for textile coating by a direct printing process. The present invention also relates to a direct printing process, including a direct automatic screen printing process.

Silicone ink base compositions, which are prior to curing in the form of liquids and after curing forming elastomeric products, are a recent addition to the silicone industry. Silicone ink bases are specialized liquid silicone rubbers (LSRs) that have been used in textile printing applications due to the soft hand feel and washing durability of the resulting treated textile.

WO 2007/039763 A1 discloses an improved silicone ink base composition for textile coating which has better film appearance and better physical properties such as softness, low-tackiness, and elongation compared to liquid silicone rubbers (LSRs) previously known.

Direct screen printing is a particularly suitable known technique or process for creating or imprinting images to various substrates. Substrates may include for example textiles and fabrics such as clothing, typically t-shirts and the like.

However, some currently available silicone inks have difficulty in adhering to some substrates, particularly performance fabrics, and/or glue during the direct printing process.

### BRIEF SUMMARY OF THE INVENTION

The present invention relates to a direct printing composition able to provide improved adhesion of the silicone ink base to substrates, particularly hard to adhere to substrates during a direct printing process. As used herein, the articles “a”, “an” and “the” each mean one or more.

### DETAILED DESCRIPTION OF THE INVENTION

In one aspect, the present invention provides a direct printing composition comprising:

(a) a silicone ink base composition;
(b) an adhesion promoter being one or more of the group comprising:

(i) an organosilane; and

(ii) a metal chelate.

Alternatively, the direct printing composition is a direct screen printing composition. Alternatively, the direct screen printing composition is a direct automatic screen printing composition.

The direct printing composition may include any proportions and/or ratios of the adhesion promoters listed above, such as 0.1 wt % to 10 wt %, alternatively 0.5 wt % to 5 wt % that does not impair the cure of the silicone ink base component. In one embodiment of the present invention, the adhesion promoter comprises at least one organosilane, alternatively two different organosilanes, and at least one zirconium chelate.

The organosilane may be a silane, an oligomeric reaction product of the silane, or a combination thereof, in particular an alkoxysilane. One or more different organosilanes may be included, alternatively two or more, alternatively two.

Alternatively, the organosilane of group (b)(i) may comprise either:

(i) the formula R³_{b}SiR⁴_{(4-b)}, where each R³ is independently a monovalent organic group; each R⁴ is an alkoxy group; and b is 0, 1, 2, or 3; or
(ii) the formula R⁵_{c}R⁶_{d}Si(OR⁵)_{4-(c+d)} where each R⁵ is independently a substituted or unsubstituted, monovalent hydrocarbon group having at least 1 carbon atom and each R⁶ contains at least one SiC bonded group having an adhesion-promoting group, such as amino, epoxy, mercapto or acrylate groups, c is 0, 1 or 2, d is 1 or 2, and the sum of c+d is not greater than 3, or in either case a partial condensate thereof.

The organosilane may comprise an alkoxysilane exemplified by a monoalkoxysilane such as trialkylalkoxysilane, dialkoxysilane, such as dialkyldialkoxysilane or a trialkoxysilane, such as an alkyltrialkoxysilane or alkenyltrialkoxysilane, or partial or full hydrolysis products thereof, or another combination thereof. Examples of suitable trialkoxysilanes include methyltrimethoxysilane, methyltriethoxysilane, ethyltrimethoxysilane, ethyltriethoxysilane, phenyltriethoxysilane, phenyltrimethoxysilane, vinyltrimethoxysilane, vinyltriethoxysilane, and a combination thereof. Examples of alkoxysilane crosslinkers are disclosed is U.S. Pat. Nos. 4,962,076; 5,051,455; and 5,053,442.

Alternatively, the organosilane may comprise a monoalkoxysilane selected from trimethylmethoxysilane, triethylmethoxysilane, tripropylmethoxysilane, triisobutylmethoxysilane, trimethylisopropoxysilane, trimethyl(methoxyethoxy)silane, trivinylmethoxysilane, or a combination thereof.

Alternatively, the organosilane may comprise a dialkoxysilane selected from chloromethylmethyldimethoxysilane, chloromethylmethyldiethoxysilane, dimethyldimethoxysilane, methyl-n-propyldimethoxysilane, (2,-dichlorocyclopropyl)-methyldimethoxysilane, (2,2-difluorocyclopropyl)-methyldiethoxysilane, (2,2-dichlorocyclopropyl)-methyldiethoxysilane, fluoromethyl-methyldiethoxysilane, fluoromethyldimethoxysilane, or a combination thereof.

Alternatively, the organosilane may comprise a trialkoxysilane selected from methyltrimethoxysilane, ethyltrimethoxysilane, propyltrimethoxysilane, isobutyltrimethoxysilane, cyclopentyltrimethoxysilane, hexyltrimethoxysilane, phenyltrimethoxysilane, 2-ethyl-hexyltrimethoxysilane, 2,3-dimethylcyclohexyltrimethoxysilane, glycidoxypropyltrimethoxysilane, aminoethylaminopropyltrimethoxysilane, (ethylenediaminepropyl)trimethoxysilane, 3-methacryloxypropyltrimethoxysilane, chloromethyltrimethoxysilane, 3-chloropropyltrimethoxysilane, trichlorophenyltrimethoxysilane, 3,3,3-trifluoropropyltrimethoxysilane, 4,4,4,3,3-pentafluorobutyltrimethoxysilane, 2,2-difluorocyclopropyltriethoxysilane, methyltriethoxysilane, cyclohexyltriethoxysilane, chloromethyltriethoxysilane, tetrachlorophenyltriethoxysilane, fluoromethyltriethoxysilane, methyltriisopropoxysilane, methyl-tris(methoxyethoxy)silane, n-propyl-tris(3-methoxyethoxy)silane, phenyltris-(methoxyethoxy)silane, vinyltrimethoxysilane, vinyltriethoxysilane, or a combination thereof.

Alternatively, the organosilane may comprise a tetraalkoxysilane selected from tetraethoxysilane, tetrapropoxysilane, tetrabutoxysilane, or a combination thereof.

The organosilane may be one or more of the group comprising a trialkoxysilane such as vinyltriethoxysilane, (methacryloxypropyl)trimethoxysilane, vinyltrimethoxysilane, vinyltriacetoxysilane, glycidoxypropyltrimethoxysilane, and combinations thereof.

Alternatively, the organosilane group is a trialkoxysilane selected from aminoethylaminopropyltrimethoxysilane, (ethylenediaminepropyl)trimethoxysilane, 3-methacryloxypropyltrimethoxysilane, vinyltrimethoxysilane, vinyltriethoxysilane, or a combination thereof. Other examples include phenyltrimethoxysilane and isobutyltrimethoxysilane.

The metal chelate of group (b) (ii) may comprise any suitable metal (such as zirconium (IV) or titanium), in the form of suitable chelate complexes such as tetraacetylacetonate, hexafluoracetylacetonate, trifluoroacetylacetonate, tetrakis (ethyltrifluoroacetylacetonate), tetrakis (2,2,6,6-tetramethyl-heptanedionato), dibutoxy bis(ethylacetonate), diisopropoxy bis(2,2,6,6-tetramethyl-heptanedionato), or β-diketone complexes, including alkyl-substituted and fluoro-substituted forms thereof.

Alternatively, the metal chelate is a zirconium chelate, such as zirconium acetylacetonate, alternatively zirconium tetrakisacetylacetonate (also termed “Zr (AcAc)₄”), (including alkyl-substituted and fluoro-substituted forms thereof).

Other metal chelate examples are described in US2010/0190396A, incorporated herein by way of reference.

In one embodiment of the present invention, the adhesion promoter in the printing composition of the present invention comprises at least two organosilanes and at least one metal chelate. In another embodiment, the adhesion promoter comprises methacryloxypropyl)trimethoxysilane, glycidoxypropyltrimethoxysilane and zirconium acetylacetonate.

The silicone ink base composition may comprise one or more silicone ink base composiitons known in the art, and the invention is not limited thereto. Alternatively, the silicone ink base is as defined in WO 2007/039763 A1, incorporated herein by way of reference.

Alternatively, the silicone ink base composition for the direct printing composition of the present invention may comprise:

(A) 100 parts by weight of a liquid polydiorganosiloxane containing at least two alkenyl radicals in each molecule,
(B) an organohydrogenpolysiloxane containing at least three silicon-bonded hydrogen atoms in each molecule, in an amount that the molar ratio of the total number of the silicon-bonded hydrogen atoms in this ingredient to the total quantity of all alkenyl radicals in ingredient (A) is from 0.5:1 to 20:1,
(C) from 5 to 50 parts by weight of a reinforcing filler, based on the amount of ingredient (A),
(D) from 0.05 to 4.5 parts by weight of a polydiorganosiloxane-polyether copolymer containing from 5 to 50 percent by mole of the polyether, based on 100 parts by weight of the combined weight of ingredients (A), (B), and (C), and (E) a hydrosilylation catalyst.

Ingredient (A) is a liquid polydiorganosiloxane containing at least two silicon-bonded alkenyl radicals in each molecule. Suitable alkenyl radicals in ingredient (A) may contain from 2 to 10 carbon atoms, alternatively vinyl, isopropenyl, allyl, and 5-hexenyl. Ingredient (A) may additionally comprise silicon-bonded organic groups other than alkenyl radicals. Such silicon-bonded organic groups are typically selected from monovalent saturated hydrocarbon radicals, which may contain from 1 to 10 carbon atoms, and monovalent aromatic hydrocarbon radicals, which may contain from 6 to 12 carbon atoms, which are unsubstituted or substituted with the groups that do not interfere with curing of this inventive composition, such as halogen atoms. Optional species of the silicon-bonded organic groups are, for example, alkyl groups such as methyl, ethyl, and propyl; halogenated alkyl groups such as 3,3,3-trifluoropropyl; and aryl groups such as phenyl.

The molecular structure of ingredient (A) is typically linear, however, there can be some branching within the molecule. To achieve a useful level of physical properties in the elastomer prepared by curing the composition of the present invention, the molecular weight of ingredient (A) should be sufficient so that it achieves a viscosity of at least 0.1 Pa·s at 25° C. The upper limit for the molecular weight of ingredient (A) is not specifically restricted and is typically limited only by the processability of the silicone ink base composition of the present invention.

Optional embodiments of ingredient (A) are polydiorganosiloxanes containing alkenyl radicals at the two terminals and are represented by the general formula (I):

R′R″R′″SiO—(R″R′″SiO)ₘ—SiR′″R″R′ (I)

In formula (I), each R′ is an alkenyl radical, which alternatively contains from 2 to 10 carbon atoms, such as vinyl, allyl, and 5-hexenyl.

R″ does not contain ethylenic unsaturation, Each R″ may be the same or different and is individually selected from monovalent saturated hydrocarbon radical, which alternatively contain from 1 to 10 carbon atoms, and monovalent aromatic hydrocarbon radical, which alternatively contain from 6 to 12 carbon atoms. R″ may be unsubstituted or substituted with one or more groups that do not interfere with curing of this inventive composition, such as halogen atoms. R′″ is R′ or R″. m represents a degree of polymerization suitable for ingredient (A) to have a viscosity of at least 0.1 Pa·s at 25° C., alternatively from 0.1 to 300 Pa·s.

Alternatively, all R″ and R′″ groups contained in a compound in accordance with formula (I) are methyl groups. Alternatively at least one R″ and/or R′″ group in a compound in accordance with formula (I) is methyl and the others are phenyl or 3,3,3-trifluoropropyl. This preference is based on the availability of the reactants typically used to prepare the polydiorganosiloxanes (ingredient (A)) and the desired properties for the cured elastomer prepared from compositions comprising such polydiorganosiloxanes.

Examples of ingredient (A) containing ethylenically unsaturated hydrocarbon radicals only in terminal groups include, but are not limited to, dimethylvinylsiloxy-terminated polydimethylsiloxane, dimethylvinylsiloxy-terminated polymethyl-3,3,3-trifluoropropylslioxane, dimethylvinylsiloxy-terminated dimethylsiloxane-3,3,3-trifluoropropylmethylsiloxne copolymer, and dimethylvinylsiloxy-terminated dimethylsiloxane/methylphenylsiloxane copolymer.

Generally, ingredient (A) has a viscosity of at least 0.1 Pa·s at 25° C., alternatively from 0.1 to 300 Pa·s., alternatively 0.1 to 100 Pa·s at 25° C.

Ingredient (B) is an organohydrogenpolysiloxane, which operates as a cross-linker for curing ingredient (A), by the addition reaction of the silicon-bonded hydrogen atoms in ingredient (B) with the alkenyl groups in ingredient (A) under the catalytic activity of ingredient (E) to be mentioned below. Ingredient (B) normally contains 3 or more silicon-bonded hydrogen atoms so that the hydrogen atoms of this ingredient can sufficiently react with the alkenyl radicals of ingredient (A) to form a network structure therewith and thereby cure the composition.

The molecular configuration of ingredient (B) is not specifically restricted, and it can be straight chain, branch-containing straight chain, or cyclic. While the molecular weight of this ingredient is not specifically restricted, the viscosity is alternatively from 0.001 to 50 Pa·s at 25° C. in order to obtain a good miscibility with ingredient (A).

Ingredient (B) may be added in an amount such that the molar ratio of the total number of the silicon-bonded hydrogen atoms in ingredient (B) to the total number of all alkenyl radicals in ingredient (A) is from 0.5:1 to 20:1. When this ratio is less than 0.5:1, a well-cured composition will not be obtained. When the ratio exceeds 20:1, there is a tendency for the hardness of the cured composition to increase when heated.

Examples of ingredient (B) include but are not limited to:

(i) trimethylsiloxy-terminated methylhydrogenpolysiloxane,
(ii) trimethylsiloxy-terminated polydimethylsiloxane-methylhydrogensiloxane,
(iii) dimethylhydrogensiloxy-terminated dimethylsiloxane-methylhydrogensiloxane copolymers,
(iv) dimethylsiloxane-methylhydrogensiloxane cyclic copolymers,
(v) copolymers composed of (CH₃)₂HSiO_{1/2} units and SiO_{4/2} units, and
(vi) copolymers composed of (CH₃)₃SiO_{1/2} units, (CH₃)₂HSiO_{1/2} units, and SiO_{4/2} units.

To achieve high level of physical properties that characterize some types of cured elastomer that can be prepared using the silicone ink composition of the present invention, it may be desirable to include a reinforcing filler such as finely divided silica. Silica and other reinforcing fillers are often treated with one or more known filler treating agents to prevent a phenomenon referred to as “creping” or “crepe hardening” during processing of the curable composition.

Finely divided forms of silica are optional reinforcing fillers. Amorphous or colloidal silicas are particularly preferred because of their relatively high surface area, which is typically at least 50 square meters per gram. Fillers having surface areas of at least 200 square meters per gram are preferred for use in the present invention. Amorphous silicas can be provided in the form of precipitated or fumed silica. Both types of silica are commercially available.

The amount of finely divided silica or other reinforcing filler used in the silicone ink composition of the present invention is at least in part determined by the physical properties desired in the cured elastomer. The silicone ink composition of the present invention typically comprises from 5 to 50 parts, alternatively from 10 to 30 parts by weight of a reinforcing filler (e.g., silica), based on the weight of the polydiorganosiloxane (ingredient (A)), alternatively 5 to 50 parts and more alternatively 10 to 30 parts for every 100 parts of ingredient A.

When the filler is naturally hydrophilic (e.g. untreated silica fillers), it is alternatively treated with a treating agent. This may be prior to introduction in the composition or in situ (i.e. in the presence of at least a portion of the other ingredients of the silicone ink composition of the present invention by blending these ingredients together until the filler is completely treated and uniformly dispersed to for a homogeneous material). Alternatively, untreated filler is treated in situ with a treating agent in the presence of ingredient (A).

Optionally the filler is surface treated using for example with a fatty acid or a fatty acid ester such as a stearate, or with organosilanes, polydiorganosiloxanes, or organosilazanes hexaalkyl disilazane or short chain siloxane diols to render the filler(s) hydrophobic and therefore easier to handle and obtain a homogeneous mixture with the other ingredients. The surface treatment of the fillers makes the fillers easily wetted by the silicone polymer. These surface modified fillers do not clump, and can be homogeneously incorporated into the silicone polymer. This results in improved room temperature mechanical properties of the uncured compositions.

Optionally the filler treating agent can be any low molecular weight organosilicon compounds disclosed in the art applicable to prevent creping of organosiloxane compositions during processing.

The treating agents are exemplified but not limited to liquid hydroxyl-terminated polydiorganosiloxane containing an average from 2 to 20 repeating units of diorganosiloxane in each molecule, hexaorganodisiloxane, hexaorganodisilazane, and the like. The hexaorganodisilazane intends to hydrolyze under conditions used to treat the filler to form the organosilicon compounds with hydroxyl groups. Alternatively, at least a portion of the silicon-bonded hydrocarbon radicals present in the treating agent are identical to a majority of the hydrocarbon radicals present in ingredients (A) and (B). A small amount of water can be added together with the silica treating agent(s) as a processing aid.

It is believed that the treating agents function by reacting with silicon-bonded hydroxyl groups present on the surface of the silica or other filler particles to reduce interaction between these particles.

The filler may be treated with the treating agent prior to formulating, and the treated filler is commercially available.

Ingredient (D) is a polydiorganosiloxane-polyether copolymer, which is represented by the general formula (II):

X_{w}R¹_{3-w}SiO(R⁷R⁸SiO)ₛ(R⁹XSiO)_{s′}SiR¹_{3-w}X_{w} (II)

(where X is —R¹⁰—(OC₂H₄)_{y}(OA)_{z}E)
wherein R¹, R⁷, R⁸, and R⁹ are independently selected from monovalent saturated hydrocarbon radicals, which may contain from 1 to 10 carbon atoms, and monovalent aromatic hydrocarbon radicals, which may contain from 6 to 12 carbon atoms; E is identical or different and selected from hydroxy, alkoxy and may contain from 1 to 6 carbon atoms, and carboxyl; A is an alkylene and may contain from 1 to 6 carbon atoms; R¹⁰ denotes an alkylene radical and may contain 2 to 6 carbon atoms; w is an integer of 0, 1, or 2, and must be 1 or 2 when d′ is zero; s is an integer of 0 to 200, and s′ is an integer of 0 to 15, where s and s′ are present in amounts relative to each other such that ingredient (D) contains from 5 to 50 percent by mole of polyether per molecule; y and z are independently integer of 0 to 30, the sum of y and z being in the range from 2 to 50.

Alternatively each R¹, R⁷, R⁸, and R⁹ is methyl. Alternatively R¹⁰ is propylene or iso-butylene. Alternatively E is hydroxyl, methoxy, or acetoxy. Alternatively A is propylene, iso-propylene, or butylene.

Ingredient (D) generally has from 5 to 50 percent by mole of polyether units. Ingredient (D) is insoluble but can be dispersed in a polydiorganosiloxane fluid (such as ingredients (A) and (B) described above. To maintain stability after mixing, the upper limit of content of polyether is 50 percent by mole, and alternatively 30 percent by mole. It is known that the percent by mole of polyether groups may be calculated using the following formula

$$\frac{number of siloxane units bonded to polyether groups}{total number of siloxane units in the molecule} \times 100$$

Ingredient (D) is added in an amount from 0.05 to 4.5 parts by weight, for every 100 parts by weight of the combined weight of ingredients (A), (B), and (C).

Curing of the direct printing composition of the present invention is catalyzed by ingredient (E), which is a hydrosilylation catalyst that is a metal selected from the platinum group of the periodic table, or a compound of such metal. The metals include platinum, palladium, and rhodium. Platinum and platinum compounds are preferred due to the high activity level of these catalysts in hydrosilylation reaction.

Example of curing catalysts include but are not limited to platinum black, platinum on various solid supports, chloroplatinic acids, alcohol solutions of chloroplatinic acid, and complexes of chloroplatinic acid with liquid ethylenically unsaturated compounds such as olefins and organosiloxanes containing ethylenically unsaturated silicon-bonded hydrocarbon radicals. Complexes of chloroplatinic acid with organosiloxanes containing ethylenically unsaturated hydrocarbon radicals are described in U.S. Pat. No. 3,419,593.

The concentration of ingredient (E) in the silicone ink base composition of the present invention is equivalent to a platinum-group metal concentration from 0.1 to 500 parts by weight of platinum-group metal, per million parts (ppm), based on the combined weight of ingredients (A) and (B).

Mixtures of the aforementioned ingredients (A), (B), and (E) may begin to cure at ambient temperature. As typical with liquid silicone rubbers (LSRs), to extend the shelf-life of the silicone ink base composition or the direct printing composition, ingredients (B) and (E) can be separated into different parts. The two parts being mixed just prior to use forming the silicone ink base composition or the direct print composition. Mixtures of aforementioned adhesion promoter ingredients comprising both the organosilane and the metal chelate may also begin to react at ambient temperature. Shelf-life of the direct printing composition can be extended by separating the organosilane(s) (i) and the metal chelate(s) (ii) into separate parts prior to mixing to form the direct printing composition.

To obtain a longer working time or pot life of the direct printing composition of the present invention, a suitable inhibitor can be used in order to retard or suppress the activity of the catalyst. For example, the alkenyl-substituted siloxanes as described in U.S. Pat. No. 3,989,887 may be used. Cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Inhibitor concentrations as low as 1 mole of inhibitor per mole of the metal will in some instances impart satisfactory storage stability and cure rate. In other instances inhibitor concentrations of up to 500 moles of inhibitor per mole of the metal are required, particularly in direct automatic screen printing compositions where high on-screen temperatures in the application can shorten working time. The optimum concentration for a given inhibitor in a given composition is readily determined by routine experimentation.

If desired, the silicone inkbase composition of the present invention may comprise ingredient (F), which may be a disiloxane or a low molecular weight polyorganosiloxane containing two silicon-bonded hydrogen atoms at the terminal positions.

When ingredient (F) is a disiloxane, it is represented by the general formula (HR^{a}₂Si)₂O, and when ingredient (F) is a polyorganosiloxane, it has terminal units of the general formula HR^{a}₂SiO_{1/2} and non-terminal units of the formula R^{b}₂SiO. In these formulae, R^{a} and R^{b} individually represent unsubstituted or substituted monovalent hydrocarbon radicals that are free of ethylenic unsaturation, which include, but are not limited to alkyl groups containing from 1 to 10 carbon atoms, substituted alkyl groups containing from 1 to 10 carbon atoms such as chloromethyl and 3,3,3-trifluoropropyl, cycloalkyl groups containing from 3 to 10 carbon atoms, aryl containing 6 to 10 carbon atoms, alkaryl groups containing 7 to 10 carbon atoms, such as tolyl and xylyl, and aralkyl groups containing 7 to 10 carbon atoms, such as benzyl.

Optionally, ingredient (F) is tetramethyldihydrogendisiloxane or dimethylhydrogen-terminated polydimethylsiloxane.

Ingredient (F) functions as chain extender for ingredient (A). In other words, ingredient (F) reacts with the alkenyl radicals of ingredient (A), thereby linking two or more molecules of ingredient (A) together and increasing its effective molecular weight and the distance between potential cross-linking sites.

Ingredient (F) may be added in an amount from 1 to 10 parts by weight, based on the weight of ingredient (A), alternatively 1 to 10 parts per 100 parts of ingredient A.

The effect of the chain extender on the properties of the cured elastomer composition is similar to that of using a higher molecular weight polyorganosiloxane, but without the processing and other difficulties associated with high viscosity curable organosiloxane composition.

Chain extenders suitable for use in the present compositions have viscosities from about 0.001 to 1 Pa·s at 25° C., alternatively from about 0.001 to 0.1 Pa·s, to maximize the concentration of silicon-bonded hydrogen atoms and minimize the viscosity of the elastomer composition of the present invention.

The number of silicon bonded hydrogen groups provided in ingredient (F), when present, and in ingredient (B) is sufficient to provide the degree of crosslinking required to cure the elastomer composition of the present invention to the desired physical property. The total quantity of silicon-bonded hydrogen atoms contributed by the crosslinker is such that the molar ratio of silicon bonded hydrogen atoms contributed by both the crosslinker and the chain extender to the vinyl or other alkenyl radicals present in the elastomer composition of the present invention is from 0.5 to 20.

If desired, a direct printing composition may also comprise: (c) one or more pigments. Suitable pigments are known in the art, and are not further discussed in detail. They include and all types of pigments, inks, tinctures, dyes, colorants and “colours”, and are included in the relevant proportions known in the art to provide the required image quantity and quality. Suitable pigments and dyes include but are not limited to carbon black, titanium dioxide, chromium oxide, bismuth vanadium oxide and the like. In one embodiment of the invention, the pigments and dyes are used in form of pigment master batches known in the art. The pigments may be dispersed in the direct printing composition at the ratio of 0.1:99.9 to 70:30 to the sum the silicone ink base of components (A) to (E).

To produce an attractive textile, the silicone ink base components are selected based on the processability requirements of the specific direct printing process being utilized. One skilled in the art can balance these requirements. For example for direct automatic screen printing on performance fabric long on-screen life, uniform screen flooding, and fast cure generally would be considered.

Generally, the direct printing composition of the present invention will have a viscosity of 10 to 250 Pa·s, alternatively 20 to 175 Pa·s, alternatively 40 to 125 Pa·s when measured at a shear rate of 10 s⁻¹ at 25° C. by means of a cone/plate geometry with cone diameter of 20 mm, a 2° arc, and a measurement gap of 53 μm.

The direct printing composition of the present invention may be prepared by combining all of ingredients or components at ambient temperature. Any mixing techniques and devices described in the prior art can be used for this purpose. The particular device to be used will be determined by the viscosities of ingredients and the final curable coating parameters of the composition. Suitable mixers include but are not limited to paddle type mixers and kneader type mixers. Cooling of ingredients during mixing may be desirable to avoid premature curing of the ink composition.

According to another aspect of the present invention, there is provided use of an adhesion promoter as defined herein to improve adhesion between a silicone ink base composition and a substrate alternatively a textile substrate during a direct printing process.

The skilled man is aware that one or more of further ingredients or components can be used in a direct printing composition, such as, but not limited to, flame-retardants, ultraviolet light stabilisers, thinners, thickeners, matting agents, puffing agents, non-reinforcing fillers such as calcium carbonate, and the like, and that a direct printing composition of the present invention may include one or more further ingredients or components or layers.

Many substrates may be coated with the direct printing composition of the present invention including textile and other substrates. Textile substrates able to be coated with the direct printing composition of the present invention include, but are not limited to, cotton, polyester, nylon and mixtures thereof together, or in combination with other materials such as a mixture of nylon comprising from 2 to 20% of an elastic fibre such as spandex.

Other substrates for which the direct printing composition of the present invention may be used include labels, patches, plastic components, in particular hard plastic components in vehicles such as automobiles, fabric components in vehicles, leather, paper, metal, plastics.

Thus, according to a third aspect of the present invention, there is provided a direct printing process for providing a silicone ink base composition onto a textile substrate or other substrate comprising at least the steps of:
(i) providing a direct printing composition as defined herein;
(ii) direct printing the composition of step (i) onto the textile substrate or other substrate to conjoin the liquid silicone base composition and the substrate; and
(iii) curing the liquid direct printing composition forming a textile garment or article including the cured elastomeric direct printing composition.

Alternatively, the direct printing process is a direct screen printing process.

Alternatively, the direct screen printing process is a direct automatic screen printing process.

According to a fourth aspect of the present invention, there is provided a textile garment or article including the direct printing composition as defined herein, and/or whenever prepared by a direct printing process as defined herein.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Each formulation was applied by screen printing to a purple nylon mesh fabric. The inks were screen printed using a 3″ (7.6 cm) square design on 110 mesh. Two layers were applied, flash curing in between the two and after last one. The final cure was done in the oven at 120 C for 2 minutes. Samples were printed in triplicate so that the testing could be done.

The following methods were used to assess the adhesion of the printed ink system to the textile substrate:

1. Taber Test Method. The Taber Test Method used for evaluating samples was derived from the ASTM Test Method D 3884-92. This method can be found in the Annual Book of ASTM Standards 2000, Section Seven, Textiles, Volume 07.02. The wheel used was H18 with 250 g of extra weight. All samples were ran for 50 cycles and then visually evaluated after the test and ranked from best to worst and observations were recorded.

2. Scrub Test Method. The Scrub Test Method was done in accordance with Dow Corning CTM 1154 based on ISO 5981. 600 cycles were completed and then the samples were visually evaluated after the test and ranked from best to worst and observations were recorded.

3. Home Laundering. The Repeated Home Laundering Test Method used for evaluating samples was derived from the AATCC Test Method 124-2006. This method can be found in the Technical Manual of the American Association of Textile Chemists and Colorist, Volume 82. All samples were washed and dried 25 times. A 4 lb ballast was used along with 66 g of Tide unscented detergent. The samples were visually inspected before and after laundering and any change was recorded.

### Silicone Ink Bases

Various adhesion promoters were added to Dow Corning® 9600, a two-component silicone ink base system commercially available from Dow Corning. This system had a viscosity of 138 Pa·s measured at a shear rate of 10 s⁻¹ at 25° C. by means of a cone/plate geometry with cone diameter of 20 mm, a 2° arc, and a measurement gap of 53 μm. This silicone ink base is identified below as “Silicone Ink Base I”. The formulation tested in Table I included 77.91 parts of silicone ink base and 25 parts of an white ink concentrate I (based on 68% TiO2 and 32% vinyl functional siloxane). All formulations are based on weight parts.

TABLE 1

| Component(s) | 18-A |
|---|---|
| Silicone Ink Base I | 77.91 |
| White Concentrate I (68% TiO2) | 25.0 |
| (Silextreme STX PGM White 200) | |

The results from testing the commercially available Silicone Ink Base I formulation of Table 1 are shown in Table 2.

TABLE 2

| | Before/After | |
|---|---|---|
| Sample | Washing | Observations |
| 18-A | Before | The coverage was ok. |
| 18-A | After | There was a small amount of color loss. |

| Sample | Observations from Taber Test |
|---|---|
| 18-A | Poor adhesion, multiple spots where ink came completely |
| | off fabric. |
| Sample | Observations from Scrub Test |
| 18-A | Ink delaminating from fabric all over area scrubbed. |

(1) Modifications to Current Silicone Ink Base I

Based on the above performance various adhesion promoters were added to silicone ink base I in order to improve adhesion and abrasion resistance. The adhesion promoters included: Methyl Hydrogen Silicon—a blend of dimethylsiloxane, dimethylhydrogensiloxy-terminated and dimethyl, methylhydrogen siloxanes, trimethylsiloxy-terminated with SiH content of 0.15-1.5%

Methacryloxypropyltrimethoxysilane (“Methacryloxy silane”),

### Glycidoxypropyltrimethoxysilane (“Epoxysilane”), and

Zr(AcAc)₄, (Zirconium Tetrakisacetylacetonate), Tyzor® TPT (tetra isopropyl titanate), Tyzor® IAM (titanium chelate), and Tyzor® AA-75 (Titanium di-isopropoxybis (2,4-pentanediol)).

The further formulations are shown in Table 3, and the results of ‘Wash’, ‘Taber’ and ‘Scrub’ tests are shown in Table 4.

TABLE 3

| Component(s) | 19-A | 19-B | 19-C | 19-D | 19-E | 19-F |
|---|---|---|---|---|---|---|
| Silicone Ink | 82.60 | 82.06 | 82.06 | 82.06 | 82.06 | 82.060 |
| Base I | | | | | | |
| White | 25.0 | 25.0 | 25.0 | 25.0 | 25.0 | 25.0 |
| Concentrate I | | | | | | |
| (68% TiO2) | | | | | | |
| (Silextreme | | | | | | |
| STX PGM | | | | | | |
| White 200) | | | | | | |
| Epoxy silane | 0.92 | 1.86 | 0.92 | 0.92 | 0.65 | 1.30 |
| Methacryloxy | 0.72 | 1.46 | 0.72 | 0.72 | 0.54 | 1.08 |
| silane | | | | | | |
| Tyzor ® TPT | 0.22 | 0.44 | | | | |
| Titanate | | | | | | |
| Tyzor ® IAM | | | 0.22 | | | |
| Tyzor ® | | | | 0.22 | | |
| AA-75 | | | | | | |
| Zr(AcAc)₄ | | | | | 0.16 | 0.33 |
| Total | 108.92 | 110.82 | 108.92 | 108.92 | 109.77 | 109.77 |

TABLE 4
Results from Testing for Modifications to Silicone Ink Base I

| | Before/After | |
|---|---|---|
| Sample | Washing | Observations |
| 19-A | Before | The ink had good coverage. |
| 19-A | After | There was a small amount of color loss. |
| 19-B | Before | The ink had good coverage. |
| 19-B | After | There was a small amount of color loss. |
| 19-C | Before | The ink had ok coverage. |
| 19-C | After | There was a small amount of color loss. |
| 19-D | Before | The ink had ok coverage, not the best. |
| 19-D | After | There was a small amount of color loss. |
| 19-E | Before | The ink had ok coverage. |
| 19-E | After | There was a small amount of color loss. |
| 19-F | Before | The ink had ok coverage. |
| 19-F | After | There was a small amount of color loss. |

| Sample | Observations from Taber Test |
|---|---|
| 19-A | Poor adhesion, multiple spots where ink came completely |
| | off fabric. |
| 19-B | Adhesion was ok, ink mostly was abraded off. Showed a lot |
| | of wear. |
| 19-C | Adhesion was ok (worse than B but still better than A), only a |
| | spot or two where the ink came completely off fabric and that |
| | was adjacent to a hole in the mesh. |
| 19-D | Adhesion was ok, ink mostly was abraded off. Showed a lot |
| | of wear. |
| 19-E | Adhesion was good, ink mostly was abraded off. Showed a |
| | small amount of wear. |
| 19-F | Adhesion was good, ink mostly was abraded off. Showed a |
| | slight amount of wear. |
| Sample | Observations from Scrub Test |
| 19-A | Ink delaminating from fabric all over area scrubbed |
| 19-B | Ink delaminating from fabric all over area scrubbed |
| 19-C | Ink delaminating from fabric all over area scrubbed |
| 19-D | Ink delaminating from fabric all over area scrubbed |
| 19-E | Ink looked like good, adhered still all over area scrubbed |
| 19-F | Ink looked like good, adhered still all over area scrubbed |

(2) ‘Color White’ Formulations II

The formulations are shown in Table 5, and the results of ‘Wash’ and ‘Taber’ tests are shown in Table 6.

TABLE 5

| Component(s) | 32-A | 32-B | 32-C | 32-D | 32-E |
|---|---|---|---|---|---|
| Silicone Base I | 82.44 | 82.44 | 82.44 | 82.44 | 82.440 |
| White | 25.0 | 25.0 | 25.0 | 25.0 | 25.0 |
| Concentrate II | | | | | |
| (50% TiO2) | | | | | |
| Epoxy silane | | | 0.65 | 1.30 | 0.65 |
| Methacryloxy | | | 0.54 | 1.08 | 0.54 |
| silane | | | | | |
| Zr(AcAc)₄ | 0.16 | 0.32 | | | 0.32 |
| Total | 107.60 | 107.76 | 108.63 | 109.82 | 108.95 |

TABLE 6

| | Before/After | |
|---|---|---|
| Sample | Washing | Observations |
| 32-A | Before | Adhesion good. |
| 32-A | After | Adhesion still good, there was no |
| | | separation. |
| 32-B | Before | Adhesion good. |
| 32-B | After | Adhesion still good, there was no |
| | | separation. |
| 32-C | Before | Adhesion good. |
| 32-C | After | Adhesion still good, there was no |
| | | separation. |
| 32-D | Before | Adhesion good. |
| 32-D | After | Adhesion still good, there was no |
| | | separation. |
| 32-E | Before | Adhesion good. |
| 32-E | After | Adhesion still good, there was no |
| | | separation. |

| Sample | Observations from Taber Test |
|---|---|
| 32-A | Coverage was ok, abrasion resistance was ok but |
| | adhesion was poor. |
| 32-B | Coverage was ok, abrasion resistance was ok but |
| | adhesion was poor. |
| 32-C | Coverage was ok, abrasion resistance was ok but |
| | adhesion was poor. |
| 32-D | Coverage was ok, abrasion resistance was ok but |
| | adhesion was poor. |
| 32-E | Coverage was ok, abrasion resistance was good and |
| | adhesion was good. |
| Sample | Observations from Scrub Test |
| 32-A | Entire area that was scrubbed was not adhered to |
| | fabric. |
| 32-B | Entire area that was scrubbed was not adhered to |
| | fabric. |
| 32-C | Entire area that was scrubbed was not adhered to |
| | fabric. |
| 32-D | Entire area that was scrubbed was not adhered to |
| | fabric. |
| 32-E | Opacity wasn't great but adhesion was good. Hardly |
| | any spots where the ink was scrubbed off. |

(3) Modifications to Silicone Base Ink Compositions and Printing with 86 Mesh Screen

The samples of silicone ink base compositions with adhesion promoters were re-tested with a lower mesh screen (86).

The formulations are shown in Table 7, and the results of various ‘Taber’ and ‘Scrub’ tests are shown in Table 8.

TABLE 7

| Component(s) | A | B | C | D | E |
|---|---|---|---|---|---|
| Silicone Ink Base I | 82.44 | 82.44 | 82.44 | 82.44 | 82.44 |
| Methyl Hydrogen | | 1.4 | | 1.4 | 1.4 |
| Silicone | | | | | |
| Crosslinker | | | | | |
| White | 25.0 | 25.0 | 25.0 | 25.0 | 25.0 |
| Concentrate II | | | | | |
| (50% TiO2) | | | | | |
| Epoxy silane | | | 0.65 | 0.65 | 1.30 |
| Methacryloxy | | | 0.54 | 0.54 | 1.08 |
| silane | | | | | |
| Zr(AcAc)₄ | | | 0.32 | 0.32 | 0.64 |
| Total | 107.44 | 108.84 | 108.95 | 110.35 | 111.86 |

TABLE 8

| | | |
|---|---|---|
| | Before/After | |
| Sample | Washing | Observations |

Wash Tests were not completed on these samples.

| Sample | Observations from Taber Test (standard test of 50 cycles) |
|---|---|
| 43-A | Adhesion looked ok, there was one spot where it was |
| | starting to fail. |
| 43-B | Adhesion was not good, ink was delaminating from |
| | fabric. |
| 43-C | Adhesion looked good, coverage wasn't good to start |
| | with, no visible signs of abrasion. |
| 43-D | Adhesion looked good, no visible signs of abrasion. |
| 43-E | Adhesion looked good, no visible signs of abrasion. |
| | Observations from Taber Test (50 additional cycles, |
| Sample | total of 100) |
| 43-A | More spots were starting to fail. |
| 43-B | Ink continued delaminating from fabric all over. |
| 43-C | Adhesion still looked good, starting to see signs of |
| | abrasion. |
| 43-D | Adhesion still looked good, hardly any visible signs of |
| | abrasion. |
| 43-E | Adhesion still looked good, starting to see signs of |
| | abrasion. |
| | Observations from Taber Test (100 additional cycles, |
| Sample | total of 200) |
| 43-A | Looking much worse, delaminating all over. |
| 43-B | Almost all ink delaminated where wheel circled. |
| 43-C | Adhesion still good, signs of abrasion more visible. |
| 43-D | Adhesion still looked good, starting to see signs of |
| | abrasion. |
| 43-E | Adhesion still good, signs of abrasion more visible. |
| | Observations from Taber Test (100 additional cycles, |
| Sample | total of 300) |
| 43-A | Did not test. |
| 43-B | Did not test. |
| 43-C | Adhesion still good, signs of abrasion more visible than |
| | prey. |
| 43-D | Adhesion still good, signs of abrasion more visible than |
| | prey. |
| 43-E | Adhesion still good, signs of abrasion more visible than |
| | prey. |
| | Observations from Taber Test (100 additional cycles, |
| Sample | total of 400) |
| 43-A | Did not test. |
| 43-B | Did not test. |
| 43-C | Adhesion still good, signs of abrasion more visible than |
| | prey. |
| 43-D | Adhesion still good, signs of abrasion more visible than |
| | prey. |
| 43-E | Adhesion still good, signs of abrasion more visible than |
| | prey. |
| Sample | Observations from Scrub Test (standard test of 600 cycles) |
| 43-A | Ink delaminated from entire area that was scrubbed. |
| 43-B | Ink delaminated from entire area that was scrubbed. |
| 43-C | Adhesion was good, very small bit of ink was starting to |
| | delaminate. |
| 43-D | Adhesion was very good. |
| 43-E | Adhesion was very good. |
| | Observations from Scrub Test (600 additional cycles, |
| Sample | total of 1200) |
| 43-A | Did not test. |
| 43-B | Did not test. |
| 43-C | Adhesion was good, slight amount of ink was starting to |
| | delaminate. |
| 43-D | Adhesion was good, ink was starting to delaminate |
| | around holes in mesh. |
| 43-E | Adhesion was good, very small bit of ink was starting to |
| | delaminate. |

From the foregoing description and examples, various modifications and changes in the compositions and methods will occur to those skilled in the art. All such modifications coming within the scope of the appended claims are intended to be included therein. Each recited range includes all combinations and sub-combinations of ranges, as well as specific numerals contained therein.

1. A direct printing composition comprising:
(a) a silicone ink base composition;
(b) an adhesion promoter being one or more of the group comprising:
(i) an organosilane; and
(ii) a metal chelate.

2. The direct printing composition of claim 1, wherein the composition is a direct screen printing composition.

3. The direct printing composition of claim 1 further comprising (c) a pigment.

4. The direct printing composition of claim 1 wherein the adhesion promoter comprises at least one organosilane, alternatively two different organosilanes, and at least one zirconium chelate.

5. The direct printing composition of claim 1 wherein the organosilane of group (i) comprises one or more of:
(i) the formula R³_{b}SiR⁴_{(4-b)}, where each R³ is independently a monovalent organic group; each R⁴ is an alkoxy group; and b is 0, 1, 2, or 3; or
(ii) the formula R⁵_{c}R⁶_{d}Si(OR⁵)_{4-(c+d)} where each R⁵ is independently a substituted or unsubstituted, monovalent hydrocarbon group having at least 1 carbon atom and each R⁶ contains at least one SiC bonded group having an adhesion-promoting group, c is 0, 1 or 2, d is 1 or 2, and the sum of c+d is not greater than 3.

6. The direct printing composition of claim 5 wherein the organosilane is one of more of a trialkoxysilane.

7. The direct printing composition of claim 1 wherein the metal chelate of group (ii) is one or more of the group comprising metal tetraacetylacetonate, hexafluoracetylacetonate, trifluoroacetylacetonate, tetrakis (ethyltrifluoroacetylacetonate), tetrakis (2,2,6,6-tetramethyl-heptanedionato), dibutoxy bis(ethylacetonate), diisopropoxy bis(2,2,6,6-tetramethyl-heptanedionato), or β-diketone, including alkyl-substituted and fluoro-substituted forms thereof, or combinations thereof.

8. The direct printing composition of claim 7 wherein the metal chelate is a zirconium chelate.

9. The direct printing composition of claim 1 wherein the adhesion promoter comprises methacryloxypropyltrimethoxysilane, glycidoxypropyltrimethoxysilane, and zirconium acetylacetonate.

10. The direct printing composition of claim 1 wherein the silicone ink base composition comprises:
(A) 100 parts by weight of a liquid polydiorganosiloxane containing at least two alkenyl radicals in each molecule,
(B) an organohydrogenpolysiloxane containing at least three silicon-bonded hydrogen atoms in each molecule, in an amount that the molar ratio of the total number of the silicon-bonded hydrogen atoms in ingredient (B) to the total quantity of all alkenyl radicals in ingredient (A) is from 0.5:1 to 20:1,
(C) from 5 to 50 parts by weight of a reinforcing filler, based on the amount of ingredient (A),
(D) from 0.05 to 4.5 parts by weight of a polydiorganosiloxane-polyether copolymer containing from 5 to 50 percent by mole of the polyether, based on 100 parts by weight of the combined weight of ingredients (A), (B), and (C), and
(E) a hydrosilylation catalyst.

11. A method of using the adhesion promoter as defined in claim 1 to improve adhesion between a silicone ink base composition and a textile substrate or other substrate during a direct printing process.

12. A direct printing process for providing a silicone ink base composition onto a substrate comprising the steps of:
(i) providing the direct printing composition of claim 1;
(ii) direct printing the composition of step (i) onto the substrate or other substrate to conjoin the silicone ink base composition and the substrate; and
(iii) curing the liquid direct printing composition forming a textile garment or article including a cured elastomeric direct printing composition.

13. The direct printing process of claim 12, wherein the process is a direct screen printing process or a direct automatic screen printing process.

14. A textile garment or article including the direct printing composition of claim 1.

15. A textile garment or article prepared by the direct printing process of claim 12.

16. The direct printing composition of claim 5 wherein the adhesion-promoting group is at least one of an amino, an epoxy, a mercapto, or an acrylate group.

17. The direct printing composition of claim 6 wherein the trialkoxysilane is one or more of the group comprising vinyltriethoxysilane, (methacryloxypropyl)trimethoxysilane, vinyltrimethoxysilane, vinyltriacetoxysilane, glycidoxypropyltrimethoxysilane, and combinations thereof.
